(19) United States
(12) Patent Application Publication
(10) Pub. No.: US 2010/0003057 A1
(43) Pub. Date: Jan. 7, 2010

(54) TONER CARTRIDGE AND DEVELOPING DEVICE AND IMAGE FORMING APPARATUS USING THE SAME

(76) Inventors: Takeshi OKUDA, Osaka (JP); Yasuyuki ISHIGURO, Osaka (JP); Takeshi WAKABAYASHI, Osaka (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/482,537

(22) Filed: Jun. 11, 2009

(30) Foreign Application Priority Data
Jul. 1, 2008 (JP) 2008-171973

(51) Int. Cl. G03G 15/08

(52) U.S. Cl. 399/263

(57) ABSTRACT

An image forming apparatus includes a photoreceptor drum, a charger, an exposure device, a developing device, a toner cartridge, a transfer device and a fusing device. The toner cartridge includes a toner container, a toner discharge port, a toner agitator, a toner discharger having a toner conveyor. The toner discharger includes a toner discharger rotary shaft for supporting toner conveyor portion, and the toner discharger rotary shaft is formed to be smaller in diameter as it goes farther in its axial direction from the toner discharge port.

This Nonprovisional application claims priority under 35 U.S.C. §119(a) on Patent Application No. 2008-171973 filed in Japan on 1 Jul., 2008, the entire contents of which are hereby incorporated by reference.

### BACKGROUND OF THE INVENTION

(1) Field of the Invention

The present invention relates to a toner cartridge as well as to a developing device and image forming apparatus using this toner cartridge, in particular, relating to a toner cartridge used for an image forming apparatus for forming images with toner, such as an electrostatic copier, laser printer, facsimile machine and the like, as well as to a developing device and image forming apparatus using this toner cartridge.

(2) Description of the Prior Art

Conventionally, in image forming apparatuses using static electrophotography such as copiers, facsimile machines, etc., that use toner, the toner is supplied to a developing device by a toner supply device including a toner cartridge or the like to perform continuous printing of images.

The image forming process of an image forming apparatus of this kind usually includes the steps of charging, exposure, development, transfer, separation, cleaning, charge erasing and fusing.

More specifically, in the process of forming images, the surface of a photoreceptor drum that is rotationally driven is uniformly electrified by a charging device (charging step). The photoreceptor drum surface thus electrified is illuminated with a laser beam from an exposure device to form an electrostatic latent image (exposure step). Subsequently, the electrostatic latent image on the photoreceptor drum is developed by a developing device to form a toner image on the photoreceptor drum surface (developing step).

The toner image on the photoreceptor drum is transferred to a transfer medium by a transfer device (transfer step), then the toner image transferred on the transfer medium is thermally heated by a fusing device and fixed to the transfer medium (fusing step).

On the other hand, the residual toner remaining on the photoreceptor drum surface after the transfer step is removed by a cleaning device and collected by a predetermined collecting portion (cleaning step). The photoreceptor drum surface after cleaning is cleared of residual charge by a charge erasing device to prepare for a next image forming operation (charge erasing step).

As the developer for developing the electrostatic latent image on the photoreceptor drum, a mono-component developer consisting of a toner only or a dual-component developer consisting of a toner and a carrier is usually used. Since a mono-component developer does not include any carrier, there is no need to have an agitating mechanism for mixing toner and carrier uniform. Hence this developing device has the advantage of a simple structure. However, there is a drawback that the amount of static charge on the toner is unlikely to be stable. On the other hand, since a dual-component developer needs to have an agitating mechanism for mixing the toner and carrier uniform, there is a drawback that the developing device becomes complex. However, since the developer presents stabile charging performance and suitability to high-speed machines, it is often used for high-speed image forming apparatuses and color image forming apparatuses.

When the toner is consumed from the dual-component developer, toner is supplied from the toner cartridge into the developing device so that the concentration of the toner in the developer in the developing hopper will not be lower than a predetermined level.

Recently, in order to meet the demands of the users for energy saving and high-quality printout of images, micro toners having a low softening temperature with a volume mean diameter as low as 5 to 9 μm have become used. Though the toner of this kind is designed to be fusible at a low fusing temperature and is effective in enhancing resolution and reducing granulation to achieve improved image quality, the toner suffers from the problem that its fluidity is low, hence the toner is prone to clump together inside the toner cartridge.

As an example of a countermeasure against this toner clumping problem, a toner cartridge including a screw-formed toner conveyor for conveying the toner stored in the storing portion to the toner discharge port, in which the screw pitch of the toner conveyor is designed to be shorter as it goes away from the toner discharge port, has been disclosed (patent document 1: Japanese Patent Application Laid-open Hei 10 No. 149005).

However, this conventional method still suffers the problem of fluidity and other problems when the toner cartridge is designed to be large or when a large amount of toner remains in the toner cartridge. That is, under the above situation, the toner is compressed due to gravity and due to rotation of the spiral toner conveyor, hence the external additives of the toner become embedded into the binder resin that constitutes the core particles of the toner, whereby the toner fluidity is lowered.

### SUMMARY OF THE INVENTION

The present invention has been devised in view of the above conventional problems, it is therefore an object of the present invention to provide a toner cartridge in which the toner is prevented from clumping together and lowering its fluidity and the discharged amount of toner will not lower when the residual amount of toner is low, as well as to provide a developing device and image forming apparatus using this toner cartridge.

In order to achieve the above object, the toner cartridge according to the present invention and the developing device and image forming apparatus using this cartridge are configured as follows:

The first aspect of the present invention resides in a toner cartridge comprising: a toner storing portion for storing toner; a toner discharge port for discharging the toner from the toner storing portion to the outside; a toner agitator that agitates the toner in the toner storing portion by rotation thereof; a toner discharger having a spiral toner conveyor portion for conveying the toner in the toner storing portion toward the toner discharge port by rotation thereof; and, a partitioning portion for separating the toner storing portion into compartments in which the toner agitator is disposed and in which the toner discharger is disposed, and is characterized in that the toner discharger includes a toner discharger rotary shaft for supporting a toner conveyor portion, and the toner discharger rotary shaft is formed to be smaller in diameter as it goes farther in the axial direction thereof from the toner discharge port.

In accordance with the second aspect of the present invention, it is preferable that the toner discharger is formed of a screw auger.

In accordance with the third aspect of the present invention, it is preferable that the toner discharge port is disposed at one end side with respect to the axial direction of the toner discharger shaft; and the toner storing portion is constructed such as to surround the toner discharger in the area where the toner discharger and the toner discharge port oppose each other. That is, a tunnel-like interior wall portion may be formed inside the toner storing portion so as to surround the toner discharger and the toner discharge port.

In accordance with the fourth aspect of the present invention, it is preferable that the vertical height of the partitioning portion is equal to or greater than the height of the rotational axis of the toner discharger and equal to or smaller than the height of the toner conveyor portion.

In accordance with the fifth aspect of the present invention, it is preferable that the toner conveyor portion is formed so that the screw pitch of at least part of the spiral becomes greater as it becomes more distant from the toner discharge port along the axial direction of the rotary shaft of the toner discharger.

Further, the sixth aspect of the present invention resides in a developing device for supplying toner to the photoreceptor drum surface on which an electrostatic latent image is formed to form a toner image, wherein a toner cartridge that stores supplementary toner is detachably attached so that the supplementary toner is supplied from the toner cartridge, and is characterized in that the toner cartridge employs any one of the toner cartridges specified in the above first to fifth aspects.

The seventh aspect of the present invention resides in an image forming apparatus for forming an image with toner based on electrophotography, comprising: a photoreceptor drum for forming an electrostatic latent image on the surface thereof; a charger for electrifying the photoreceptor drum surface; an exposure device for forming an electrostatic latent image on the photoreceptor drum surface; a developing device for forming a toner image by supplying toner to the electrostatic latent image on the photoreceptor drum surface; a toner cartridge for supplying toner to the developing device; a transfer device for transferring the toner image on the photoreceptor drum surface to a recording medium; and a fusing device for fusing the toner image on the recording medium, and characterized in that the toner cartridge employs any one of the toner cartridges specified in the above first to fifth aspects.

According to the first aspect of the present invention, since toner can be conveyed more rapidly as the toner is located farther from the toner discharge port and more slowly and gently as it approaches the toner discharge port, it is possible to suppress variation in toner density and pressure of the toner around the toner discharge port and hence prevent the toner around the toner discharge port from clumping together and lowering its fluidity. Further, since it is possible to form a toner pool around the toner discharge port even if the amount of remaining toner is lowered, it is possible to keep the toner density and pressure of the toner around the toner discharge port constant and realize stable toner discharge without reduction of the quantity of discharged toner.

According to the second aspect of the present invention, since toner can be smoothly conveyed by rotation of the toner discharger, it is possible to make the amount of toner conveyance stable, and thereby keep constant the toner density and pressure of the toner around the toner discharge port and realize stable toner discharge.

According to the third aspect of the present invention, since the amount of toner supplied from the top around the toner discharge port is limited, it is possible to keep the toner density and pressure around the toner discharge port constant.

According to the fourth aspect of the present invention, even if a large amount of toner is supplied by the toner agitator, it is possible to prevent toner from being compressed and clumping together around the toner discharge port because the toner built up higher than the partitioning portion falls to the toner agitator side.

Also, according to the fifth aspect of the present invention, since the toner can be conveyed faster as it is located farther from the toner discharge port, it is possible to form a toner pool around the toner discharge port even if the amount of remaining toner is lowered, so that it is possible to realize stable toner discharge without reduction of the quantity of discharged toner.

Further, according to the sixth aspect of the present invention, since the amount of toner supplied from the toner cartridge is made stable, it is possible to realize a developing device excellent in controllability of toner density.

Finally, according to the seventh aspect of the present invention, since the toner density of a dual-component developer can be stabilized, it is possible to provide an image forming apparatus which can produce stable images free from fogging and image density unevenness.

### BRIEF DESCRIPTION OF THE DRAWINGS

FIG. 1 is an illustrative view showing an embodied configuration of an image forming apparatus using a toner cartridge according to the present invention;

FIG. 2 is a front sectional view showing a toner cartridge, a developing device and its surroundings that constitute the image forming apparatus.

FIG. 3 is a front sectional view showing the configuration of the toner cartridge;

FIG. 4 is a sectional view, cut along planes A1-A2 in FIG. 2;

FIG. 5 is a sectional view, cut along a plane B1-B2 in FIG. 2;

FIG. 6 is an illustrative view of a toner cartridge according to the present embodiment, showing a state of toner conveyance when a greater amount of toner is supplied on the toner discharger side;

FIG. 7 is an illustrative view of a toner cartridge according to the present embodiment, showing a state of toner conveyance when a lower amount of toner is supplied on the toner discharger side;

FIG. 8 is an illustrative view of a comparative example of a toner cartridge, which includes a toner discharger having a toner discharger rotary shaft of a uniform diameter, showing a state of toner conveyance when a greater amount of toner is supplied on the toner discharger side;

FIG. 9 is an illustrative view of a comparative example of a toner cartridge, which includes a toner discharger having a toner discharger rotary shaft of a uniform diameter, showing a state of toner conveyance when a lower amount of toner is supplied on the toner discharger side; and,

FIG. 10 is an illustrative view showing a toner cartridge configuration according to another embodiment of the present invention.

### DESCRIPTION OF THE PREFERRED EMBODIMENTS

### The First Embodiment

The best mode for carrying out the present invention will hereinafter be described with reference to the drawings.

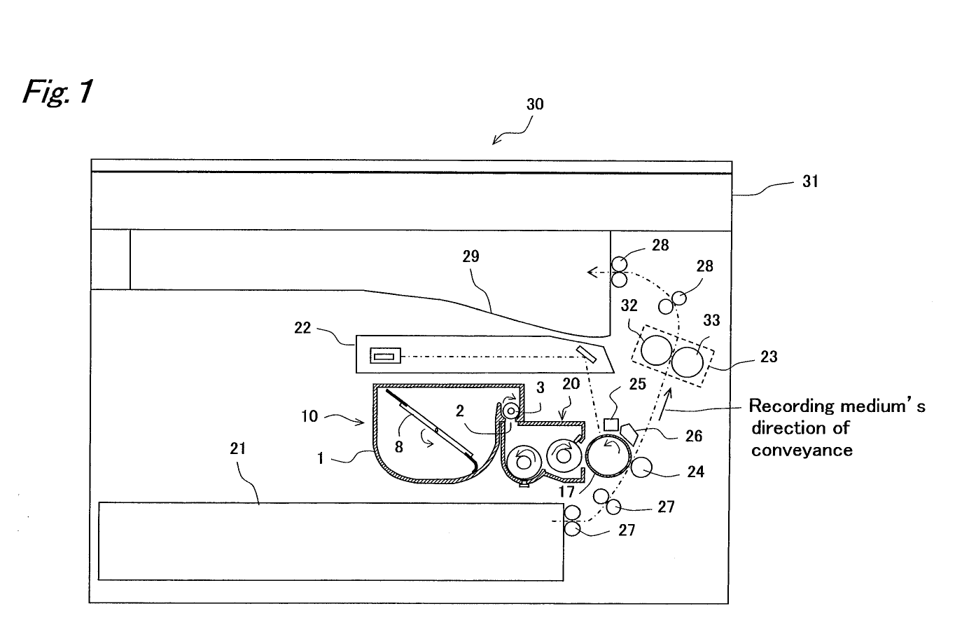

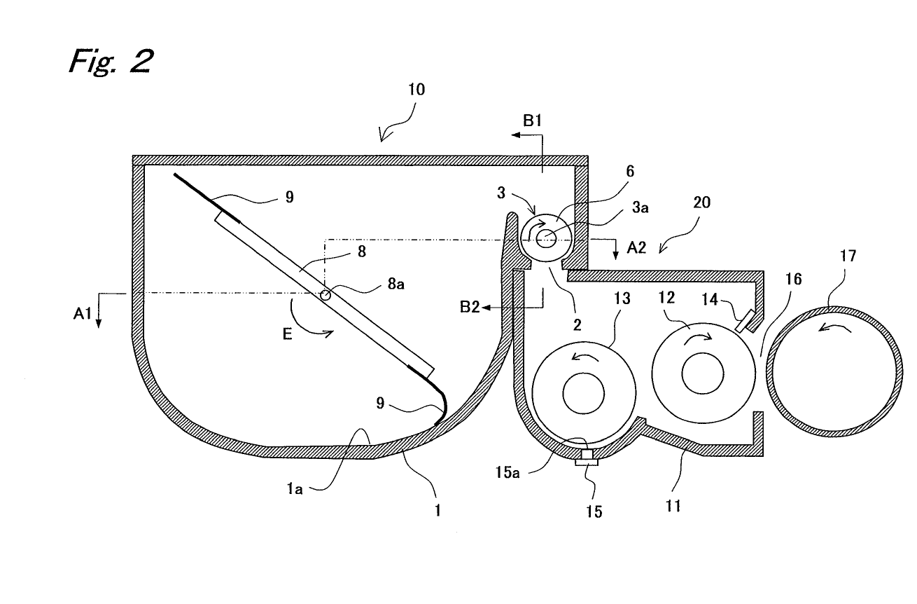

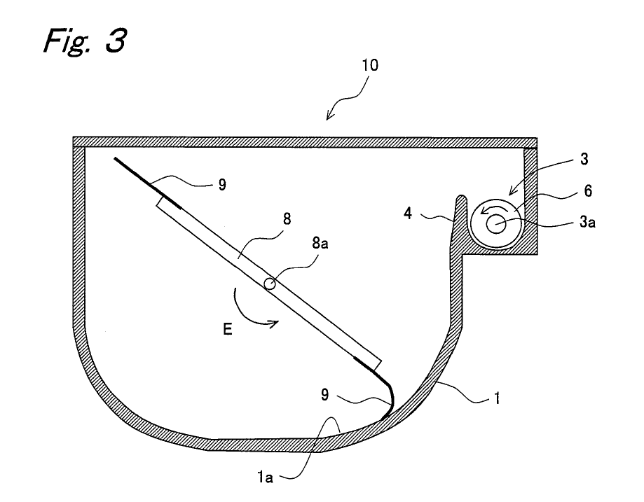

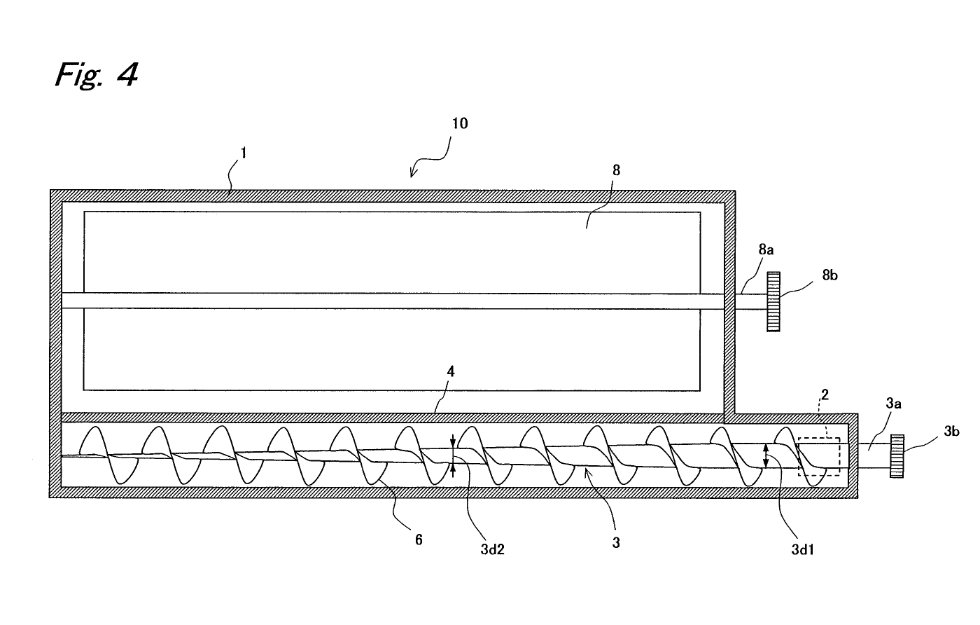

FIG. 1 is an illustrative view of one exemplary embodiment of the present invention, showing an overall configuration of an image forming apparatus using a toner cartridge according to the present invention. FIG. 2 is a front sectional view showing a toner cartridge, a developing device and its surroundings that constitute the image forming apparatus. FIG. 3 is a front sectional view showing the configuration of the toner cartridge. FIG. 4 is a sectional view, cut along planes A1-A2 in FIG. 2.

An image forming apparatus 30 of the present embodiment includes: as shown in FIG. 1, a photoreceptor drum 17 on the surface of which an electrostatic latent image is formed; a charger 25 for electrifying the photoreceptor drum 17 surface; an exposure device 22 for forming an electrostatic latent image on the photoreceptor drum 17 surface; a developing device 20 for supplying toner to the photoreceptor drum 17 surface to develop the electrostatic latent image into a toner image; and a toner cartridge 10 for supplying toner to developing device 20, and visualizes the electrostatic latent image formed on photoreceptor drum 17 as a toner image, based on electrophotography.

As shown in FIG. 2, toner cartridge 10 according to the present embodiment includes a toner discharger 3 that rotates to discharge toner from a toner container (toner storing portion) 1 to the outside thereof; and a toner agitator 8 for agitating toner inside toner container 1, and is constructed so as to be detachably attached to developing device 20 that is mounted in image forming apparatus 30.

To begin with the overall configuration of image forming apparatus 30 will be described.

As shown in FIG. 1, image forming apparatus 30 according to the present embodiment, includes toner cartridge 10, developing device 20, photoreceptor drum 17, charger 25, exposure device 22, a cleaning device 26, a transfer device 24, a fusing device 23, a paper feed cassette 21, a paper output tray 29 and a scanner unit 31.

Photoreceptor drum 17 is a roller-like member, which is axially supported and rotationally driven by an unillustrated driver and on the surface of which an electrostatic latent image, and hence its toner image is formed. As photoreceptor drum 17, a roller-shaped member of an unillustrated conductive base with a photo-sensitive layer formed thereon may be used, for example. As the conductive base, a pipe-like, cylindrical, sheet-like conductive base may be used. Of these, a cylindrical conductive base is preferable. As photoreceptor drum 17, an organic photoreceptor drum, inorganic photoreceptor drum and the like may be employed.

The organic photoreceptor drum may be given as a lamination-type photoreceptor drum in which a charge generating layer of a resin coating containing a charge generating substance and a charge transport layer of a resin coating containing a charge transport substance are laminated or may be given as a mono-layered photoreceptor drum in which a single resin coating that contains both a charge generating substance and a charge transport substance is formed.

The inorganic photoreceptor drum may be given as a film coating containing one, or two or more kinds of substances selected from zinc oxide, selenium, amorphous silicon and the like. A primer coating may be inserted between the conductive base and the photo-sensitive layer. A surface coating (protective coating) for principally protecting the photoreceptor drum can be formed on the surface of the photoreceptor drum.

Charger 25 is to perform corona discharge over photoreceptor drum 17, and employs a saw-toothed charger. Other than the saw-toothed charger, a charger type electrifier, a charging brush type charger, a roller-type charger, a magnetic brush and other contact type chargers may be used.

Though not illustrated, a power supply is connected to charger 25 so as to apply voltage to charger 25. That is, charger 25 is adapted to receive voltage application from the power supply and electrify the photoreceptor drum 17 surface at a predetermined voltage of a predetermined polarity.

Exposure device 22 receives input of image information of originals read by scanner unit 31 or input of image information from an external device, and irradiates the photoreceptor drum 17 surface having been electrostatically electrified, with signal light in accordance with the image information. By this process, an electrostatic latent image corresponding to the image information is formed on the photoreceptor drum 17 surface. As this exposure device 22, a laser scanning system including a light source is used.

The laser scanning system is a unit that includes, for example a light source, a polygon mirror, an f-θ lens, reflection mirrors and other elements. As the light source, a semiconductor laser, LED array, electroluminescence (EL) device and the like can be used.

Developing device 20 includes, as shown in FIG. 2, toner cartridge 10, a developing hopper 11, an agitating roller 13, a developing roller 12, a regulatory member 14 and a toner concentration detecting sensor 15.

Developing hopper 11 is a container that has an approximately semi-cylindrical configuration having an interior space, rotatably supporting agitating roller 13 and developing roller 12 and stores a dual-component developer made of a toner and a carrier.

Agitating roller 13 is rotationally driven by an unillustrated driver to agitate the dual-component developer stored in developing hopper 11.

Developing roller 12 is a roller-shaped member that is to convey the dual-component developer to photoreceptor drum 17 and is rotationally driven about its axis by an unillustrated driver. Developing roller 12 is provided opposing photoreceptor drum 17 through opening 16 of developing hopper 11 with a predetermined gap apart from photoreceptor drum 17.

The dual-component developer conveyed by developing roller 12 comes in contact with photoreceptor drum 17 in the area where developing roller 12 approaches most closely to the drum. This contact area forms the developing nip, where toner is supplied from the developer on the developing roller 12 surface to the electrostatic latent image on the photoreceptor drum 17 surface by application of a developing bias voltage to developing roller 12 from an unillustrated power supply connected to developing roller 12.

Regulatory member 14 is formed of a plate-like member that extends parallel to the axial direction of developing roller 12 and is arranged so that its one long side at top is supported by developing hopper 11 above developing roller 12 while the other long side at bottom is positioned a gap apart from the developing roller 12 surface. This regulatory member 14 may be formed of stainless steel, or may be formed of aluminum, synthetic resin or the like.

Toner concentration detecting sensor 15 is disposed at the bottom surface of developing hopper 11 vertically below agitating roller 13 so that its sensor face (top surface) 15a is exposed to the interior of developing hopper 11. Toner concentration detecting sensor 15 is electrically connected to an unillustrated controller. This controller performs control in accordance with the detection result from toner concentration detecting sensor 15 so as to rotationally drive toner discharger 3 and supply toner into the developing hopper 11 through a toner discharge port 2.

For example, when the detected result from toner concentration detecting sensor 15 is determined to be lower than a set toner concentration level, the controller sends a control signal to the driver for rotationally driving toner discharger 3 so as to rotationally drive toner discharger 3.

Toner concentration detecting sensor 15 may use a general detection sensor. Examples include transmitted light detecting sensors, reflected light detecting sensors, magnetic permeability detecting sensors, etc. Of these, magnetic permeability detecting sensors are preferable.

A magnetic permeability detecting sensor is a sensor that receives application of a control voltage and outputs a result of toner concentration detection as an output voltage. Since the sensor is basically sensitive in the middle range of the output voltage, the applied control voltage is adjusted so as to produce an output voltage around that range. Magnetic permeability detecting sensors of this kind are found on the market, examples including TS-L, TS-A and TS-K (any of these are trade names of products of TDK Corporation).

Toner concentration detecting sensor 15 using a magnetic permeability sensor is connected to an unillustrated power supply. This power supply applies the drive voltage for driving toner concentration detecting sensor 15 and the control voltage for outputting the detected result of toner concentration to the controller. Application of voltage to toner concentration detecting sensor 15 from the power supply is controlled by the controller.

Transfer device 24 is a roller-shaped member that is rotatably supported by an unillustrated supporting structure and arranged in press-contact with photoreceptor drum 17 so as to be rotationally driven by an unillustrated drive means.

As transfer device 24, a roller-shaped member formed of a metal core having a diameter of, for example 8 to 10 mm and an elastic conductive layer formed on the surface of the metal core is used. As the metal forming the metal core, stainless steel, aluminum or the like may be used. As the elastic conductive layer, rubber material, such as ethylene-propylene rubber (EPDM), foamed EPDM, foamed urethane, etc., in which a conductive substance such as carbon black etc. is blended, can be used.

Recording medium is fed, one sheet at a time, from paper feed cassette 21 by a paper feed roller 27 into the press-contact portion (transfer nip portion) between photoreceptor drum 17 and transfer device 24 in synchronization with the toner image conveyed by rotation of photoreceptor drum 17.

As the recording medium passes through the transfer nip portion between photoreceptor drum 17 and transfer device 24, the toner image on the photoreceptor drum 17 surface is transferred to the recording medium.

An unillustrated power supply is connected to transfer device 24 so as to apply voltage of an opposite polarity to that of static charge on the toner that forms the toner image, to transfer device 24 when the toner image is transferred to the recording medium. Thus, the toner image is smoothly transferred to the recording medium.

Cleaning unit 26includes an unillustrated cleaning blade and an unillustrated toner storing vessel. The cleaning blade is a plate-like member that extends parallel to the axial direction of photoreceptor drum 17 and is arranged so as to abut its long edge on one short end side against the photoreceptor drum 17 surface. This cleaning blade abuts the surface of rotating photoreceptor drum 17, and removes toner, paper particles and the like that remain on the photoreceptor drum 17 surface after transfer of the toner image to the recording medium, from the photoreceptor drum 17 surface. The toner storing vessel is a container-like member having a hollow space therein and temporarily stores the toner removed off by the cleaning blade. The thus constructed cleaning unit 26 cleans the photoreceptor drum 17 surface after toner image transfer.

Fusing device 23 includes a fusing roller 32 and pressing roller 33. Fusing roller 32 is a roller-shaped member that is rotatably supported by an unillustrated structure and can be axially rotated by an unillustrated driver. This fusing roller 32 has an unillustrated heating element therein to heat and fuse the toner that forms the unfixed toner image carried on the recording medium being conveyed from the transfer nip portion, to thereby fix the image to the recording medium.

As fusing roller 32, a roller-shaped member formed of, for example, a metal core and an elastic layer is used. The metal core is formed of metal such as iron, stainless steel, aluminum or the like. The elastic layer is formed of an elastic material such as silicone rubber, fluororubber, etc. The heating element generates heat as it is supplied with voltage from an unillustrated power supply. The heating element may use a halogen lamp, infrared lamp or the like.

Pressing roller 33 is a roller-shaped member that is rotatably supported and pressed against fusing roller 32 by an unillustrated pressing member. This pressing roller 33 is driven to rotate following the rotation of fusing roller 32. The press-contact portion between fusing roller 32 and pressing roller 33 forms the fusing nip portion.

Pressing roller 33 assists the fixing of the toner image to the recording medium by pressing the melting toner to the recording medium when the toner image is heated and fused to the recording medium by fusing roller 32. Pressing roller 33 may use a roller-shaped member having the same configuration as fusing roller 32. Pressing roller 33 may also include a heating element therein. As this heating element the same one in fusing roller 32 may be used.

In fusing device 23, when the recording medium with a toner image transferred thereon is passed through the fusing nip portion, the toner that forms the toner image is fused and pressed to the recording medium so that the toner image is fixed to the recording medium. The recording medium with an image printed thereon is discharged to paper output tray 29 by means of a paper output roller 28.

Paper feed cassette 21 is a tray for holding recording media such as plain paper, coated paper, color copy paper, OHP film sheets and the like. An unillustrated pickup roller and conveying rollers feed recording media, one sheet at a time, to the transfer nip portion in synchronization with conveyance of the toner image on the photoreceptor drum 17 surface.

Scanner unit 31 is equipped with an unillustrated document set tray, a reversing automatic document feeder (PADF) and the like and also includes an unillustrated document reading device.

The automatic document feeder feeds originals set on the document set tray to the original table of the document reading device. The document reading device includes the original table, a document scanner, reflecting components and a line sensor of a photoelectric transducer (charge coupled device, which will be referred to hereinbelow as ‘CCD’) so as to read the image information of the original placed on the original table every multiple lines, for example, every ten lines.

The original table is formed of a glass plate member on which an original is placed to read image information therefrom.

The document scanner includes an unillustrated light source and a first reflecting mirror, moving along, and parallel to, the underside of the original table at a fixed speed V in a reciprocating manner so as to illuminate the image surface of the document placed on the original table with light. A reflected light image can be obtained by this light illumination.

The light source is a light emitter for emitting light over the original placed on the original table.

The first reflecting mirror reflects the reflected light image to a reflecting assembly.

This reflecting assembly includes unillustrated second and third reflecting mirrors and an optical lens to focus the reflected light image obtained by the document scanner onto the CCD line sensor. The reflecting assembly reciprocates at a speed of V/2 following the reciprocating movement of the document scanner.

The second and third reflecting mirrors reflect the reflected light image toward the optical lens. The optical lens focuses the reflected light image onto the CCD line sensor. The CCD line sensor includes an unillustrated CCD circuit for photoelectrically converting the reflected light image focused by the optical lens into electric signals and outputs the electric signals carrying the image information to the image processor in the controller.

The image processor converts the image information supplied from the document reading device or an external device such as a personal computer or the like into electric signals, which are output to exposure device 22.

Next, toner cartridge 10 according to the present embodiment will be described in detail with reference to the drawings.

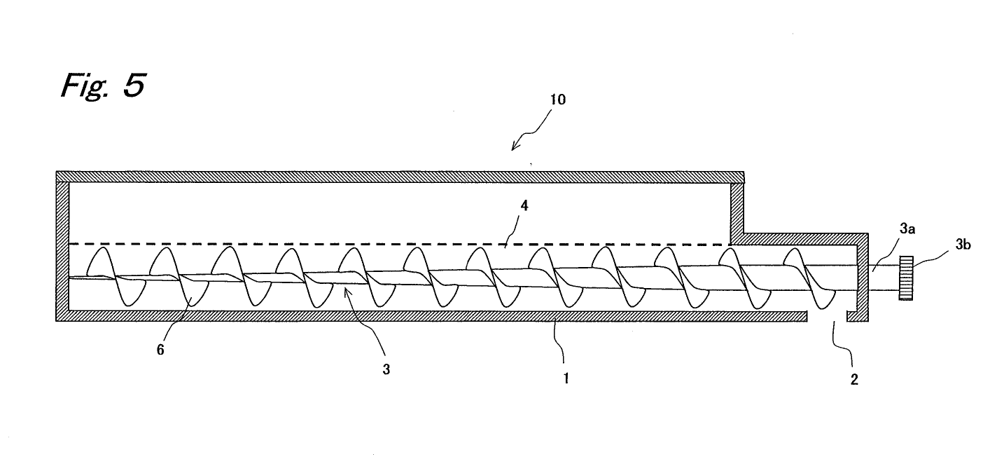

FIG. 5 is a sectional view, cut along a plane B1-B2 in FIG. 2.

As shown in FIGS. 2 and 3, toner cartridge 10 includes toner container 1, a toner agitator 8, toner scooping blades 9, toner discharger 3 and toner discharge port 2. Toner discharger 3 and toner agitator 8 are constructed to be rotated by driving force transferred through an unillustrated gear transmission from a drive motor.

Toner container 1 is an approximately semi-cylindrical container member having an interior space to hold toner therein and supports toner agitator 8 and toner discharger 3 in a rotatable manner.

Also, as shown in FIGS. 2 and 4, toner container 1 is formed such that its one end with respect to the axial direction of toner discharger 3 is projected and a toner discharge port 2 of a rectangular opening is formed in the projected portion, vertically under toner discharger 3.

As shown in FIGS. 1 and 2, toner discharge port 2 is disposed at the position opposing developing device 20 of image forming apparatus 30 when toner cartridge 10 is mounted to image forming apparatus 30.

Toner agitator 8 is integrally formed with a rotary shaft 8a, an agitation gear 8b (FIG. 4) and toner scooping blades 9 (FIG. 3), and is adapted to rotate about rotary shaft 8a and agitate the toner stored in toner container 1 as drive force is transferred through agitation gear 8b.

Toner scooping blades 9 are formed of a flexible polyethylene terephthalate (PET) sheet of about 0.5 to 2 mm thick and attached at both longitudinal sides of toner agitator 8 in order to scoop up toner in toner container 1 and convey to toner discharger 3.

The toner cartridge 10 according to the present embodiment is, as shown in FIG. 2, constituted of a toner discharger 3 that discharges toner stored in toner container (toner storing portion) 1 to the outside of toner container 1 by rotation and toner agitator 8 that agitates toner in toner container 1, which is detachablly attached to developing device 20 of image forming apparatus 30.

As shown in FIGS. 2 and 4, toner discharger 3 is to supply toner conveyed by toner scooping blades 9, from toner discharge port 2 to developing hopper 11, and is constituted of a toner discharger rotary shaft 3a, a discharger gear 3b and a toner conveyor portion 6. Toner discharger rotary shaft 3a is formed to be smaller in diameter as it goes farther from toner discharge port 2 in the axial direction of rotary shaft 3a of toner discharger 3.

Specifically, toner discharger rotary shaft 3a is formed so that the shaft diameter 3d1 near toner discharge port 2 is smaller than that in the position away from toner discharge port 2, for example, the shaft diameter 3d2 located in the middle part of toner cartridge 10, as shown in FIG. 4.

Toner conveyor portion 6 is formed of a so-called screw auger, which is formed of a continuous spiral blade, or is formed of a spiral coil, and is rotated through discharger gear 3b by drive force from an unillustrated drive motor.

The spiral direction of toner conveyor portion 6 is designed so that toner can be conveyed from one axial end of toner discharger 3 toward toner discharge port 2, as shown in FIG. 4.

Provided between toner discharger 3 and toner agitator 8 is a toner discharger partition (partitioning portion) 4 that separates the interior space of toner container 1 into two storing compartments on the toner discharger 3 side and on the toner agitator 8 side along the axial direction of toner discharger 3 as shown in FIGS. 4 and 5. This toner discharger partition 4 enables a suitable amount of toner to be scooped up by toner agitator 8 and held around toner discharger 3.

Next, the operation of supplying toner from toner cartridge 10 to developing device 20 in image forming apparatus 30 will be described.

When toner is supplied from toner cartridge 10 to developing device 20, in toner cartridge 10 toner agitator 8 is rotated in the direction of arrow E as shown in FIG. 2 so as to scoop up toner by scooping blades 9 towards toner discharger 3 while agitating the toner inside toner container 1.

At this time, toner scooping blades 9 rotate as they are deforming and sliding over inner wall 1a of toner container 1 due to the flexibility of the material that forms the blades, whereby the toner on the downstream side with respect to the rotational direction, or the toner residing on the right side (close to developing device 20) in toner container 1 and over the toner scooping blade 9 in FIG. 2, is supplied to toner discharger 3 side.

A predetermined amount of toner that is supplied to the toner discharger 3 side is reserved over toner discharger 3 by toner discharger partition 4 (FIG. 3) while excess toner falls to the toner agitator 8 side. As a result, it is possible to keep the amount of toner to be conveyed by toner discharger 3 uniform.

The toner supplied to the toner discharger 3 side is conveyed toward toner discharge port 2 by rotation of toner discharger 3 and supplied to developing device 20 through toner discharge port 2 (FIG. 2).

The vertical height of toner discharger partition 4 is preferably designed to be equal to or greater than the height of rotational axis of toner discharger 3 and equal to or smaller than the height of toner discharger 3.

The reasons are as follows: That is, if toner discharger partition 4 is so formed as to be higher than the height of toner discharger 3, the density of the toner becomes higher due to the function of toner conveyance by rotation of toner discharger 3 and due to gravity on the toner, so that the external additives strongly adhere to the binder resin that forms the core particles of toner, hence the fluidity of the toner is likely to lower. On the other hand, if toner discharger partition 4 is formed so as to be lower than the height of the rotational center of toner discharger 3, it becomes difficult to form a stable amount of toner pool around toner discharge port 2, hence the discharged amount of toner becomes liable to change.

In the present embodiment, since toner discharger 3 has toner conveyor portion 6 formed of toner discharger rotary shaft 3a and a continuous spiral blade and is constructed such that toner discharger rotary shaft 3a becomes smaller in diameter or the sectional area of the blade of toner conveyor portion 6 is made greater as it goes farther from toner discharge port 2 in the axial direction of toner discharger rotary shaft 3a, the more distant the toner is located from toner discharge port 2, the greater amount of toner is conveyed. As a result, if the amount of toner supplied by toner scooping blades 9 decreases, toner is collected around toner discharge port 2, hence it is possible to create a stable amount of toner pool. Therefore, it is possible to keep the toner density and the pressure acting on the toner around toner discharge port 2 constant and stabilize the discharged amount of toner from toner discharge port 2.

Referring now to the drawings, the toner discharging function of the toner cartridge of the present embodiment will be compared with that of the conventional toner cartridge having a typical configuration.

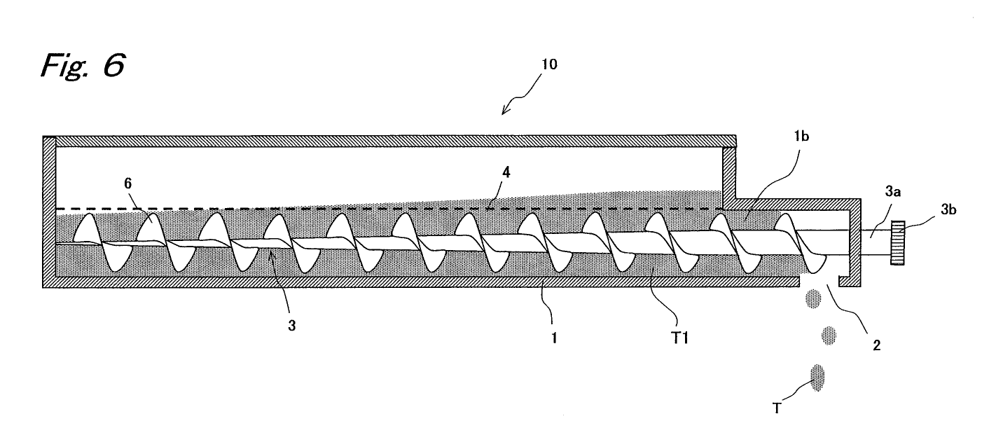

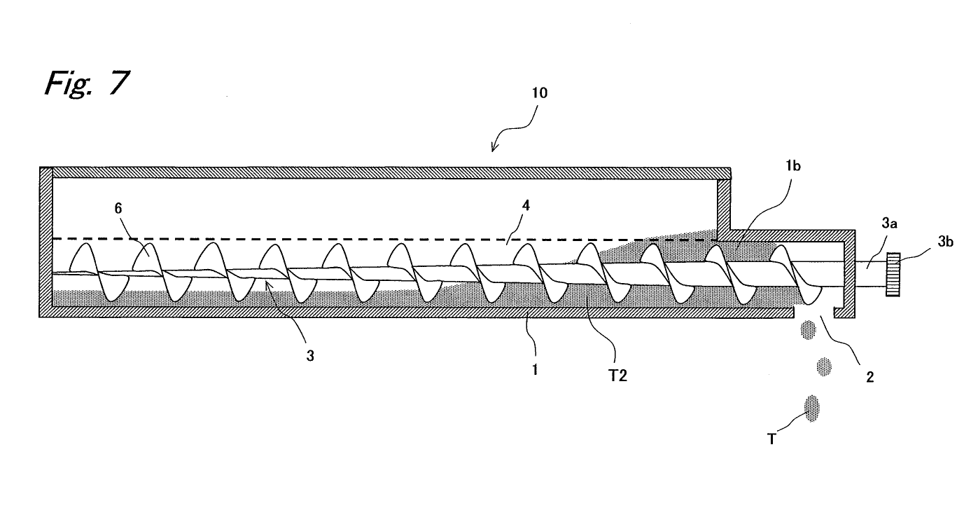

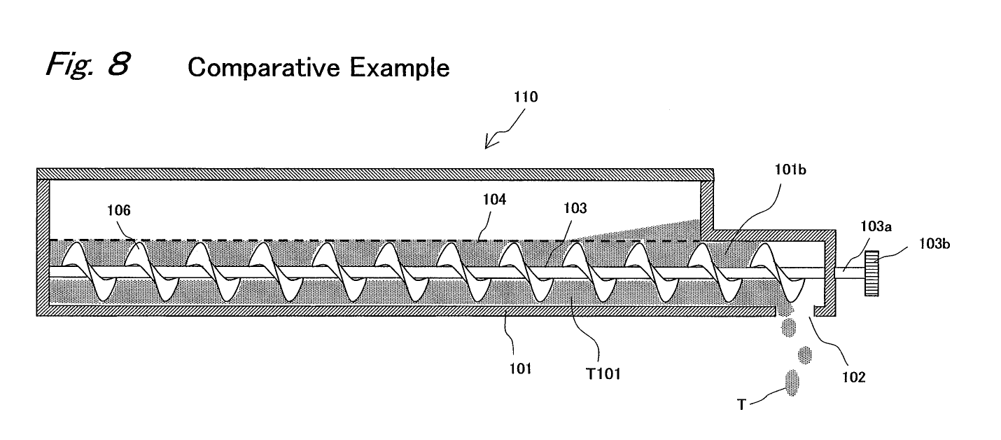

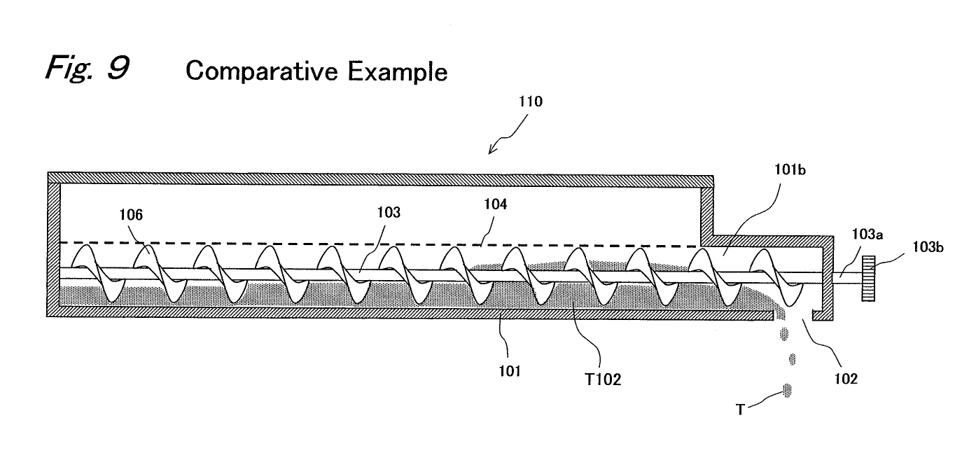

FIG. 6 is an illustrative view of the toner cartridge according to the present embodiment, that includes a toner discharger constructed such that the toner discharger rotary shaft becomes smaller in diameter as it goes farther from the toner discharge port in the axial direction of the toner discharger rotary shaft, showing a state of toner conveyance when a greater amount of toner is supplied on the toner discharger side. FIG. 7 is an illustrative view of the same toner cartridge, showing a state of toner conveyance when a lower amount of toner is supplied on the toner discharger side. FIG. 8 is an illustrative view of a comparative example of a toner cartridge which includes a toner discharger having a toner discharger rotary shaft of a uniform diameter, showing a state of toner conveyance when a greater amount of toner is supplied on the toner discharger side. FIG. 9 is an illustrative view of the toner cartridge as the same comparative example, showing a state of toner conveyance when a lower amount of toner is supplied on the toner discharger side.

First, the toner discharging function of a toner cartridge 110 shown in FIGS. 8 and 9, in which the toner discharger rotary shaft, designated at 103a, of a toner discharger 103, has a shaft of a uniform diameter will be described as a comparative toner cartridge example.

When toner cartridge 110 holds a large amount of toner, a large quantity of toner is supplied to the toner discharger 103 side by an unillustrated toner agitator, as shown in FIG. 8, and a sufficient amount of toner pool is formed around atoner discharge port 102 (tunnel entrance 101b). As a result, it is possible to discharge a stable amount of toner from toner discharge port 102. A reference numeral 104 in the drawing designates a toner discharger partition and T designates toner being discharged.

In contrast, however, when toner cartridge 110 holds a lower amount of toner, the quantity of toner supplied to toner discharger 103 by the toner agitator lowers as shown in FIG. 9, so that little toner pool is formed around toner discharge port 102. As a result, the amount of toner discharged from toner discharge port 102 decreases.

Accordingly, in the toner cartridge 110 as a comparative example, as the amount of toner in toner cartridge 110 varies, the amount of toner supplied to toner discharger 103 side also varies. As a result, it is impossible to stably supply toner to developing device 20 because the amount of toner T101 and T102 (FIGS. 8 and 9) pooled on the toner discharger side 103 varies.

On the other hand, in toner cartridge 10 of the present embodiment, when toner cartridge 10 holds a large amount of toner, a large quantity of toner is supplied to the toner discharger 3 side by toner agitator 8, as shown in FIG. 6. However, since the amount of toner to be pooled on the toner discharger 3 side is limited by toner discharger partition 4, a toner pool of a stable quantity is formed around toner discharge port 2 (tunnel entrance 1b). As a result, it is possible to keep the amount of toner conveyed by toner discharger 3 constant and discharge a stable amount of toner from toner discharge port 2.

When toner cartridge 1 holds a lower amount of toner, the quantity of toner supplied to toner discharger 3 side by toner agitator 8 lowers, as shown in FIG. 7. However, since the more distant the toner is located from toner discharge port 2 the toner is conveyed faster by toner discharger 3, the toner can be gathered on the downstream side with respect to the direction of toner conveyance, and it is possible to create a toner pool of a stable quantity around toner discharge port 2. As a result, it is possible to suppress variation in toner density and pressure of the toner around toner discharge port 2, hence discharge a stable amount of toner from toner discharge port 2.

Accordingly, in toner cartridge 10 of the present embodiment, even if the supplied quantity of toner to the toner discharger 3 side varies depending on the amount of toner in toner cartridge 10 and hence the amount of toner T1, T2 (FIGS. 6 and 7) pooled on the toner discharger 3 side varies, stable toner supply to developing device 20 can be carried out.

According to the present embodiment thus constructed, since, in toner discharger 3 including spiral toner conveyor portion 6 provided for toner cartridge 10, the toner discharger rotary shaft is formed to be smaller in diameter as it goes farther from toner discharge port 2 in the axial direction of toner discharger rotary shaft 3a, it is possible to secure higher toner conveyance performance in the area more distant from toner discharge port 2 and reduce the toner conveyance capacity toward the area around toner discharge port 2. As a result, it is possible to form a toner pool around the toner discharge port even if the amount of remaining toner is lowered and it is possible to keep constant the toner density and pressure around the toner discharge port and realize stable toner discharge without reduction of the discharged quantity of toner.

Further, since toner discharger 3 can gather toner to and around toner discharge port 2 to form a toner pool of a stable quantity even if the amount of toner remaining inside toner cartridge 10 is lowered, it is possible to realize stable toner supply to developing device 20 without reduction of the discharged quantity of toner.

In the above way, according to image forming apparatus 30 of the present embodiment, since it is possible with toner cartridge 10 to carry out stable toner supply to developing device 20, highly qualified images can be produced in a stable manner.

Further, according to the present embodiment, use of a drill-like screw auger as toner conveyor portion 6 enables smooth conveyance of toner by rotation of toner conveyor portion 6, hence it is possible to make the amount of toner conveyance stable.

Moreover, according to the present embodiment, since the tunnel-shaped arrangement of covering toner discharger 3 around toner discharge port 2 inside toner container 1 makes it possible to limit the amount of toner supplied to the top of toner discharge port 2 by toner agitator 8, it is possible to keep the toner density and pressure around toner discharge port 2 constant. As a result, it is possible to stabilize the amount of toner to be discharged from toner discharge port 2.

### The Second Embodiment

Next, the second of a toner cartridge according to the present invention will be described

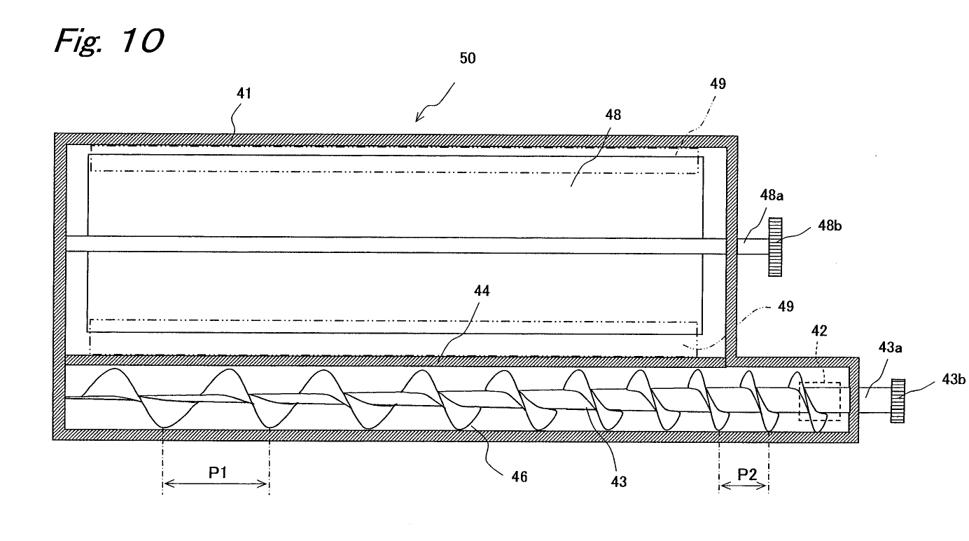

FIG. 10 is an illustrative view showing a toner cartridge configuration according to the second embodiment of the present invention.

As shown in FIG. 10, toner cartridge 50 of the second embodiment includes a toner container 41, a toner agitator 48, toner scooping blades 49, a toner discharger 43 and a toner discharge port 42. Toner discharger 43 and toner agitator 48 are constructed to be rotated by driving force transferred through an unillustrated gear transmission from a drive motor.

Similarly to toner container 1 in the above embodiment toner container 41 is an approximately semi-cylindrical container member having an interior space to hold toner therein and supports toner agitator 48 and toner discharger 43 in a rotatable manner. Provided between toner discharger 43 and toner agitator 48 is a toner discharger partition (partitioning portion) 44 that separates the interior space of toner container 41 into two storing compartments on the toner discharger 43 side and on the toner agitator 48 side along the axial direction of toner discharger 43.

Also, as shown in FIG. 10, toner container 41 is formed such that its one end with respect to the axial direction of toner discharger 43 is projected and a toner discharge port 42 of a rectangular opening is formed in the projected portion, vertically under toner discharger 43.

Toner agitator 48 is integrally formed with a rotary shaft 48a, an agitation gear 48b and toner scooping blades 49, and is adapted to rotate about rotary shaft 48a and agitate the toner stored in toner container 41 as drive force is transferred through agitation gear 48b.

Toner scooping blades 49 are formed of a flexible polyethylene terephthalate (PET) sheet of about 0.5 to 2 mm thick and attached at both longitudinal sides of toner agitator 48 in order to scoop up toner in toner container 41 and convey to toner discharger 43.

As shown in FIG. 10, toner discharger 43 is to supply toner conveyed by toner scooping blades 49, from toner discharge port 42 to developing hopper 11, and is constituted of a toner discharger rotary shaft 43a, a discharger gear 43b and a toner conveyor portion 46. Toner discharger rotary shaft 43a is formed to be smaller in diameter as it goes farther from toner discharge port 42 in the axial direction of rotary shaft 43a of toner discharger 43.

Also, toner conveyor portion 46 is formed so that the screw pitch of part of the spiral becomes greater as it becomes more distant from toner discharge port 42 along the axial direction of rotary shaft 43a of toner discharger 43.

Specifically, in the present embodiment, as shown in FIG. 10, toner conveyor portion 46 is formed so that the screw pitch P1 at a distant position from toner discharge port 42 is greater than the screw pitch P2 at a position close to toner discharge port 42. The screw pitch between the portion with screw pitch P1 and the portion with screw pitch P2 is designed to become gradually greater as it goes away from toner discharge port 42 along the axial direction of rotary shaft 43a of toner discharger 43.

In the second embodiment, in addition to the configuration of the first embodiment, the screw pitch of toner conveyor portion 46 is designed to become greater as it becomes more distant along the axial direction of toner discharger 43 from toner discharge port 42, so that the more distant the toner is located from toner discharge port 42, the faster it is conveyed. As a result, if the amount of toner supplied by toner scooping blades 49 decreases extremely, toner is collected around toner discharge port 42, hence it is possible to create a stable amount of toner pool. Therefore, it is possible to stabilize the amount of toner discharged from toner discharge port 42.

Though the above first and second embodiments were described taking examples in which the toner cartridge of the present invention is applied to image forming apparatus 30 shown in FIG. 1, as long as it is an image forming apparatus in which toner is supplied to a developing device using a toner cartridge, the invention can be developed to any other image forming apparatus and the like, not limited to the image forming apparatus and copier described above.

Having described heretofore, the present invention is not limited to the above first and second embodiments, and various changes can be made within the scope of the appended claims. That is, any embodied mode obtained by combination of technical means modified as appropriate without departing from the spirit and scope of the present invention should be included in the technical art of the present invention.

What is claimed is:

1. A toner cartridge comprising:
a toner storing portion for storing toner;
a toner discharge port for discharging the toner from the toner storing portion to the outside;
a toner agitator that agitates the toner in the toner storing portion by rotation thereof;
a toner discharger having a spiral toner conveyor portion for conveying the toner in the toner storing portion toward the toner discharge port by rotation thereof; and,
a partitioning portion for separating the toner storing portion into compartments in which the toner agitator is disposed and in which the toner discharger is disposed,
characterized in that the toner discharger includes a toner discharger rotary shaft for supporting a toner conveyor portion, and
the toner discharger rotary shaft is formed to be smaller in diameter as it goes farther in the axial direction thereof from the toner discharge port.

2. The toner cartridge according to claim 1, wherein the toner discharger is formed of a screw auger.

3. The toner cartridge according to claim 1, wherein the toner discharge port is disposed at one end side with respect to the axial direction of the toner discharger rotary shaft,
the toner storing portion is constructed such as to surround the toner discharger in the area where the toner discharger and the toner discharge port oppose each other.

4. The toner cartridge according to claim 1, wherein the vertical height of the partitioning portion is equal to or greater than the height of the rotational axis of the toner discharger and equal to or smaller than the height of the toner conveyor portion.

5. The toner cartridge according to claim 1, wherein the toner conveyor portion is formed so that the screw pitch of at least part of the spiral becomes greater as it becomes more distant from the toner discharge port along the axial direction of the rotary shaft of the toner discharger.

6. A developing device for supplying toner to the photoreceptor drum surface on which an electrostatic latent image is formed to form a toner image, wherein a toner cartridge that stores supplementary toner is detachably attached so that the supplementary toner is supplied from the toner cartridge, characterized in that the toner cartridge employs the toner cartridge defined in claim 1.

7. An image forming apparatus for forming images with toner based on electrophotography, comprising:
a photoreceptor drum for forming an electrostatic latent image on the surface thereof;
a charger for electrifying the photoreceptor drum surface;
an exposure device for forming an electrostatic latent image on the photoreceptor drum surface;
a developing device for forming a toner image by supplying toner to the electrostatic latent image on the photoreceptor drum surface;
a toner cartridge for supplying toner to the developing device;
a transfer device for transferring the toner image on the photoreceptor drum surface to a recording medium; and
a fusing device for fusing the toner image on the recording medium,
characterized in that the toner cartridge employs the toner cartridge defined in claim 1.
